(19) United States
(12) Patent Application Publication
(10) Pub. No.: US 2023/0318009 A1
(43) Pub. Date: Oct. 5, 2023

(54) MANUFACTURING TOOL FOR SOLID ELECTROLYTE SHEET

(71) Applicant: HONDA MOTOR CO., LTD., Tokyo (JP)

(72) Inventors: Yohei NOJI, Saitama (JP); Akihiro YOSHIZAWA, Saitama (JP); Takahiro MACHIDA, Saitama (JP); Yusuke YOSHIZAKI, Saitama (JP)

(21) Appl. No.: 18/191,890

(22) Filed: Mar. 29, 2023

(30) Foreign Application Priority Data
Mar. 31, 2022 (JP) 2022-060941

(51) Int. Cl. H01M 10/04

(52) U.S. Cl. CPC H01M 10/0404

(57) ABSTRACT

A manufacturing tool for a solid electrolyte sheet is a manufacturing tool for a solid electrolyte sheet configured such that a porous base is filled with a solid electrolyte material. The manufacturing tool includes a first frame member and a second frame member each having opposing sandwiching portions and sandwiching the base by the sandwiching portions. The sandwiching portions provide a fixing structure configured of provide tension to the sandwiched base.

This application is based on and claims the benefit of priority from Japanese Patent Application No. 2022-060941, filed on 31 Mar. 2022, the content of which is incorporated herein by reference.

### BACKGROUND OF THE INVENTION

### Field of the Invention

The present invention relates to a manufacturing tool for a solid electrolyte sheet.

### Related Art

Conventionally, repeatedly-chargeable and -dischargeable secondary batteries typified by lithium-ion batteries have been in widespread use. The secondary battery of this type has problems in, e.g., safety against electrolytic solution leakage and heat because this secondary battery uses, as an ion transfer medium, an electrolytic solution such as an organic solvent. For this reason, a solid-state battery using an inorganic solid electrolyte instead of an organic electrolyte has been proposed and developed.

Normally, the solid-state battery has such a structure that a solid electrolyte layer is sandwiched between a positive electrode and a negative electrode. For example, a solid electrolyte layer of a lithium-ion solid-state battery has a function of conducting lithium ions and a separator function of preventing a short-circuit between a positive electrode active material layer of a positive electrode and a negative electrode active material layer of a negative electrode. The solid electrolyte layer functioning as the separator is preferably formed as thin as possible in order to improve energy density, and in addition, preferably ensures such a strength that cracks, etc. are not caused.

In response to such a demand, a solid electrolyte sheet has been proposed, which is configured such that an opening of a support is filled with a solid electrolyte (see, e.g., Japanese Unexamined Patent Application, Publication No. 2013-127982).
Patent Document 1: Japanese Unexamined Patent Application, Publication No. 2013-127982

### SUMMARY OF THE INVENTION

As described in Japanese Unexamined Patent Application, Publication No. 2013-127982, the solid electrolyte sheet is manufactured in such a manner that, e.g., molten slurry of a solid electrolyte material is applied to a base such as the support. However, if the base is wrinkled or loosened, considerable variation in the thickness of the solid electrolyte sheet exists after manufacturing. If the sheet-shaped base varying in thickness is used to form a cell, battery performance is degraded due to influence of the thickness variation.

An object of the present invention is to provide a manufacturing tool capable of producing a thin and uniform solid electrolyte sheet.

(1) The present invention relates to a manufacturing tool for a solid electrolyte sheet configured such that a porous base is filled with a solid electrolyte material, the manufacturing tool including a first frame member and a second frame member each having opposing sandwiching portions and sandwiching the base by the sandwiching portions. The sandwiching portions provide a fixing structure capable of providing tension to the sandwiched base.

(2) The fixing structure is preferably a recessed-raised structure.

(3) The recessed-raised structure preferably includes a raised portion continuously provided at the sandwiching portion of the first frame member and a recessed portion provided at the sandwiching portion of the second frame member such that the recessed portion can receive the raised portion with the base sandwiched between the recessed portion and the raised portion.

According to the present invention, the thin and uniform solid electrolyte sheet can be manufactured.

### BRIEF DESCRIPTION OF THE DRAWINGS

FIG. 1 is a perspective view showing a manufacturing tool according to one embodiment of the present invention;

FIG. 2 is a partial sectional view of a solid-state battery including a solid electrolyte sheet manufactured using the manufacturing tool according to one embodiment of the present invention;

FIG. 3 is a perspective view schematically showing the structure of the solid electrolyte sheet manufactured using the manufacturing tool according to one embodiment of the present invention;

FIG. 4 is an exploded view of a first frame member and a second frame member forming the manufacturing tool according to one embodiment of the present invention;

FIG. 5 is a partial sectional view of the manufacturing tool of one embodiment of the present invention along an A-A line of FIG. 1;

FIG. 6A is a partial sectional view of the manufacturing tool of one embodiment of the present invention along a B-B line of FIG. 1, the view showing a state in which a base is arranged between the first frame member and the second frame member separated from each other;

FIG. 6B is a partial sectional view of the manufacturing tool of one embodiment of the present invention along the B-B line of FIG. 1, the view showing a state in which the base is sandwiched between the first frame member and the second frame member;

FIG. 7 is a front view schematically showing the base sandwiched by the manufacturing tool according to one embodiment of the present invention;

FIG. 8 is a schematic view for describing steps of manufacturing the solid electrolyte sheet by the manufacturing tool according to one embodiment of the present invention; and

FIG. 9 is a graph showing the average thickness of the solid electrolyte sheet and variation in the thickness in an example and a comparative example.

### DETAILED DESCRIPTION OF THE INVENTION

Hereinafter, an embodiment of the present invention will be described with reference to the drawings. Note that the embodiment described below is an example of the present invention and the present invention is not limited to the embodiment below.

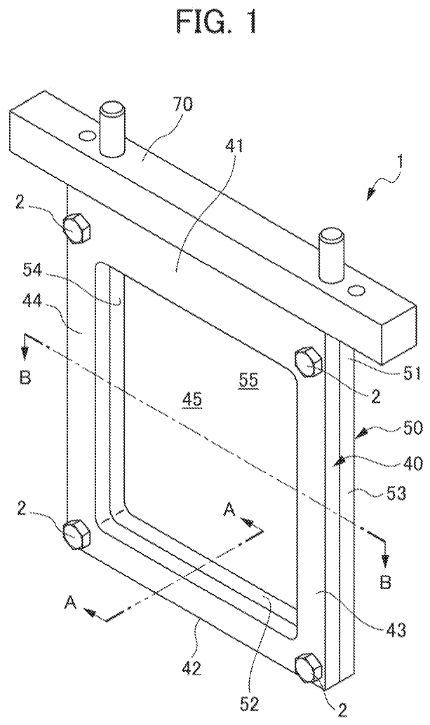

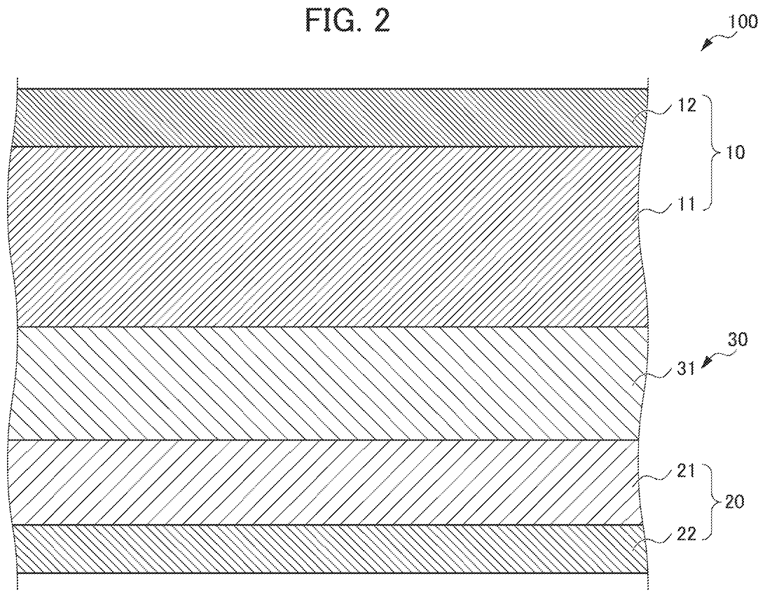

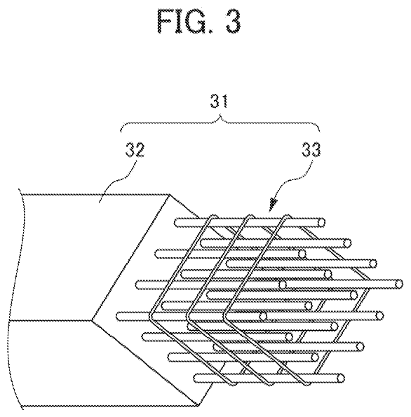

FIG. 1 is a perspective view showing a manufacturing tool 1, FIG. 2 is a partial sectional view of a solid-state battery 100, and FIG. 3 is a perspective view schematically showing the structure of a solid electrolyte sheet 31. The manufacturing tool 1 according to the embodiment is used for manufacturing the solid electrolyte sheet 31 included in the solid-state battery 100. The solid electrolyte sheet 31 manufactured using the manufacturing tool 1 and the solid-state battery 100 including the solid electrolyte sheet 31 will be described before describing the manufacturing tool 1.

As shown in FIG. 2, the solid-state battery 100 includes a positive electrode 10, a negative electrode 20, and a solid electrolyte layer 30. The solid-state battery 100 is a stack of the positive electrode 10, the solid electrolyte layer 30, and the negative electrode 20 stacked in this order. The solid-state battery 100 of the embodiment is a lithium-ion solid-state battery. Note that the solid-state battery described in the present specification means an all-solid-state battery.

The positive electrode 10 has a positive electrode layer 11 and a positive electrode current collector 12. The positive electrode layer 11 is arranged on a solid electrolyte layer 30 side. The positive electrode current collector 12 forms a positive-electrode-10-side surface of the solid-state battery 100.

The positive electrode layer 11 contains a positive electrode active material. The positive electrode active material used for the positive electrode layer 11 is not particularly limited, and may only be required to function as the positive electrode of the solid-state battery 100. Note that specific examples of the positive electrode active material may include, as sulfide-based materials, titanium sulfide (TiS₂), molybdenum sulfide (MoS₂), iron sulfide (FeS, FeS₂), copper sulfide (CuS), and nickel sulfide (Ni₃S₂). As oxide-based materials, the examples may include bismuth oxide (Bi₂O₃), bismuth plumbate (Bi₂Pb₂O₅), copper oxide (CuO), vanadium oxide (V₆O₁₃), lithium cobalt oxide (LiCoO₂), lithium nickel oxide (LiNiO₂), lithium manganese oxide (LiMnO₂), Li(NiCoMn)O₂, Li(NiCoAl)O₂, and Li(NiCo)O₂. These materials may be used alone or in combination.

The positive electrode current collector 12 has a function of collecting current from the positive electrode layer 11. The positive electrode current collector 12 is a foil member made of an electrode material having conductivity. The electrode material used for the positive electrode current collector 12 is not particularly limited as long as the material has conductivity, and for example, includes vanadium, aluminum, stainless steel, gold, platinum, manganese, iron, and titanium. Among these materials, aluminum is preferable. The shape and thickness of the positive electrode current collector 12 are not particularly limited as long as the positive electrode current collector 12 can collect current from the positive electrode layer 11.

The negative electrode 20 has a negative electrode layer 21 and a negative electrode current collector 22. The negative electrode layer 21 is arranged on the solid electrolyte layer 30 side. The negative electrode current collector 22 forms a negative-electrode-20-side surface of the solid-state battery 100.

The negative electrode layer 21 contains a negative electrode active material. The negative electrode active material used for the negative electrode layer 21 is not particularly limited, and may only be required to function as the negative electrode of the solid-state battery 100. The negative electrode active material preferably contains at least one of a Li-based material or a Si-based material. Note that specific examples of the negative electrode active material include carbon materials such as artificial graphite, a graphite carbon fiber, resin-calcined carbon, pyrolytic vapor-grown carbon, coke, a mesocarbon microbead (MCMB), furfuryl alcohol resin-calcined carbon, polyacene, a pitch-based carbon fiber, a vapor-grown carbon fiber, natural graphite, and non-graphitizable carbon. Alternatively, these materials may be used in combination. The examples further include metals themselves such as metallic lithium, metallic indium, metallic aluminum, and metallic silicon and alloys with combinations of these metals and other elements or compounds.

The negative electrode current collector 22 has a function of collecting current from the negative electrode layer 21. The negative electrode current collector 22 is a foil member made of an electrode material having conductivity. The electrode material used for the negative electrode current collector 22 is not particularly limited as long as the material has conductivity, and for example, includes vanadium, stainless steel, manganese, iron, titanium, copper, nickel, cobalt, and zinc. Among these materials, copper and nickel are preferable because these materials have excellent conductivity and excellent current collecting properties. The shape and thickness of the negative electrode current collector 22 are not particularly limited as long as the negative electrode current collector 22 can collect current from the negative electrode layer 21.

The solid electrolyte layer 30 includes the solid electrolyte sheet 31. The solid electrolyte sheet 31 is a sheet formed in such a manner that a sheet-shaped porous base 33 is filled with a solid electrolyte material. As shown in FIG. 3, the solid electrolyte sheet 31 includes a solid electrolyte 32, the porous base 33 arranged in the solid electrolyte 32, and a not-shown binder mixed with the solid electrolyte 32. The solid electrolyte 32 includes a portion where the solid electrolyte material is bound with the binder. The solid electrolyte 32 may have a portion where no binder is contained. The solid electrolyte layer 30 including the solid electrolyte sheet 31 is arranged between the positive electrode 10 and the negative electrode 20.

The porous base 33 is preferably a woven or non-woven fabric. In the case of the woven or non-woven fabric, the base 33 has moderate porosity and thickness, and is easily filled with the solid electrolyte material. The material of the base 33 is not particularly limited, and may only be required to form a self-standing sheet. Examples of the material include polyethylene terephthalate, nylon, aramid, Al₂O₃, and glass. The base 33 preferably contains heat-resistant fibers. The base 33 contains the heat-resistant fibers so that the risk of a short-circuit occurring can be reduced even if pressing is performed at, e.g., a high temperature exceeding 200° C. in, e.g., a step of manufacturing the solid-state battery 100. The solid electrolyte 32 can be sintered by high-temperature pressing, and as a result, interfacial resistance can be lowered and battery output can be improved.

Note that the base 33 forming the solid electrolyte sheet 31 in the present invention preferably contains aramid fibers or Al₂O₃ fibers among the heat-resistant fibers. If the base 33 contains the aramid fibers or the Al₂O₃ fibers, fiber deformation due to heat is less likely to occur.

The solid electrolyte material used for the solid electrolyte sheet 31 may only be required to conduct lithium ions between the positive electrode 10 and the negative electrode 20, and is not particularly limited. Examples of the solid electrolyte material include an oxide-based electrolyte and a sulfide-based electrolyte. Note that the same material as the sulfide-based electrolyte used for the positive electrode layer 11 may be used as the solid electrolyte material used for the solid electrolyte sheet 31.

The solid electrolyte 32 of the solid electrolyte sheet 31 preferably contains lithium. In this regard, a substance synthesized from lithium sulfide as a first component and a second component which is one or more compounds selected from a group consisting of silicon sulfide, phosphorus sulfide, and boron sulfide is preferable, and Li₂S—P₂S₅ is more preferable in terms of lithium ion conductivity.

In a case where the solid electrolyte 32 of the solid electrolyte sheet 31 is the sulfide-based electrolyte, the solid electrolyte 32 may further contain a sulfide such as SiS₂, GeS₂, or B₂S₃. Li₃PO₄, halogen, or a halogen compound may be added to the solid electrolyte 32 as necessary, for example.

In a case where the solid electrolyte 32 of the solid electrolyte sheet 31 is a lithium ion conductor containing an inorganic compound, examples of the solid electrolyte 32 include Li₃N, LISICON, LIPON(Li_{3+y}PO₄₋ₓNₓ), Thio-LISICON(Li_{3.25}Ge_{0.25}P_{0.75}S₄), and Li₂O—Al₂O₃—TiO₂—P₂O₅(LATP).

The solid electrolyte 32 of the solid electrolyte sheet 31 may have a non-crystalline, glass-like, or crystalline (crystallized glass) structure. In a case where the solid electrolyte 32 is a sulfide-based solid electrolyte containing Li₂S—P₂S₅, the lithium ion conductivity of the non-crystalline body is about 10⁻⁴ Scm⁻¹. On the other hand, in the case of the crystalline body, the lithium ion conductivity is about 10⁻³ Scm⁻¹.

The solid electrolyte 32 of the solid electrolyte sheet 31 preferably contains at least one of phosphorus or sulfur. With this configuration, the ion conductivity of the obtained solid-state battery 100 can be improved.

The binder can adhere to the surface of the base 33 to bond the solid electrolyte material to such a surface. For example, the binder preferably contains adhesive resin having adhesiveness. Examples of the solid electrolyte material include (meth)acrylic-based thermoplastic resin, silicone resin, urethane resin, nitrile-based resin, polyester-based resin, cellulose-based resin, styrene-based resin, styrene-butadiene-based resin, vinyl acetate-based resin, fluoroethylene-based resin, polyvinyl ether, and rubber. Note that “(meth)acrylic” is a general term for acrylic and methacrylic.

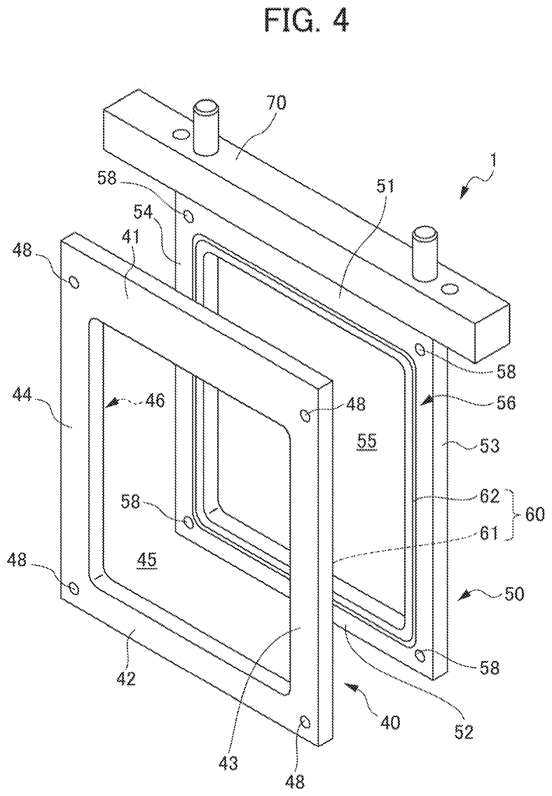

Next, the manufacturing tool 1 for the solid electrolyte sheet 31 will be described with reference to FIGS. 1 and 4. FIG. 4 is an exploded view of a first frame member 40 and a second frame member 50 forming the manufacturing tool 1.

The manufacturing tool 1 includes the first frame member 40, the second frame member 50, and a hanger 70. The manufacturing tool 1 is configured to sandwich the base 33 with the first frame member 40 and the second frame member 50 overlapping with each other.

The first frame member 40 is formed in a rectangular frame shape by an upper frame portion 41, a lower frame portion 42, and vertical frame portions 43, 44 which are elongated flat plate-shaped portions. The lower frame portion 42 has the substantially same length as that of the upper frame portion 41, and is formed substantially in parallel with the upper frame portion 41 with a space from the upper frame portion 41. The vertical frame portion 43 is formed so as to extend from one end of the upper frame portion 41 in a length direction thereof to one end of the lower frame portion 42 in a length direction thereof. The vertical frame portion 44 is formed so as to extend from the other end of the upper frame portion 41 in the length direction thereof to the other end of the lower frame portion 42 in the length direction thereof. That is, the vertical frame portion 44 is formed substantially in parallel with the vertical frame portion 43 with a space from the vertical frame portion 43. The first frame member 40 has an opening 45 surrounded and formed by the upper frame portion 41, the lower frame portion 42, and the vertical frame portions 43, 44.

At four corners of the first frame member 40, through-holes 48 penetrating the first frame member 40 in a thickness direction thereof are formed such that bolts 2 are insertable into the through-holes 48.

The first frame member 40 further has a sandwiching portion 46 formed at a surface 47 facing the second frame member 50 with the first frame member 40 overlapping with the second frame member 50 and provided for sandwiching the base 33. The configuration of the sandwiching portion 46 will be described later.

The second frame member 50 is formed in a rectangular frame shape by an upper frame portion 51, a lower frame portion 52, and vertical frame portions 53, 54 which are elongated flat plate-shaped portions. The lower frame portion 52 has the substantially same length as that of the upper frame portion 51, and is formed substantially in parallel with the upper frame portion 51 with a space from the upper frame portion 51. The vertical frame portion 53 is formed so as to extend from one end (the right end portion in FIG. 1) of the upper frame portion 51 in a length direction thereof to one end of the lower frame portion 52 in a length direction thereof. The vertical frame portion 54 is formed so as to extend from the other end (the left end portion in FIG. 1) of the upper frame portion 51 in the length direction thereof to the other end of the lower frame portion 52 in the length direction thereof. That is, the vertical frame portion 54 is formed substantially in parallel with the vertical frame portion 53 with a space from the vertical frame portion 53. The second frame member 50 has an opening 55 surrounded and formed by the upper frame portion 51, the lower frame portion 52, and the vertical frame portions 53, 54. The second frame member 50 is formed with the substantially same size as that of the first frame member 40.

At four corners of the second frame member 50, through-holes 58 penetrating the second frame member 50 in a thickness direction thereof are formed such that the bolts 2 are insertable into the through-holes 58. The four through-holes 58 are each formed so as to overlap with the through-holes 48 with the first frame member 40 and the second frame member 50 overlapping with each other.

The second frame member 50 further has a sandwiching portion 56 formed at a surface 57 facing the first frame member 40 with the second frame member 50 overlapping with the first frame member 40 and provided for sandwiching the base 33. The first frame member 40 and the second frame member 50 sandwich the base 33 by the sandwiching portions 46, 56. The configuration of the sandwiching portion 56 will be described later.

The hanger 70 is a member that holds and hangs the manufacturing tool 1. The hanger 70 is attached to an upper surface of the upper frame portion 51 of the second frame member 50.

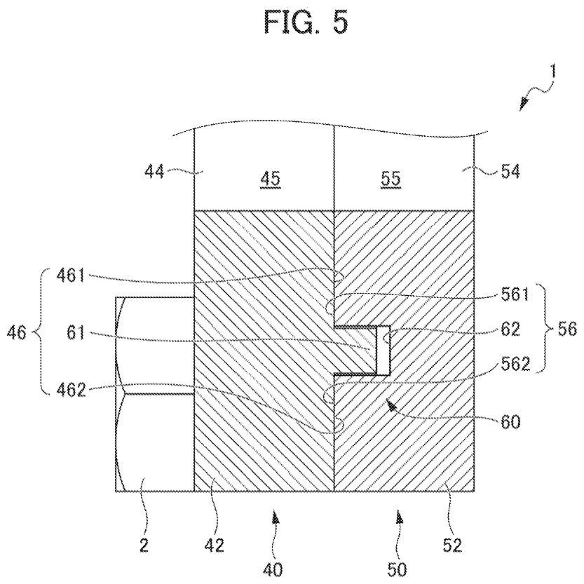

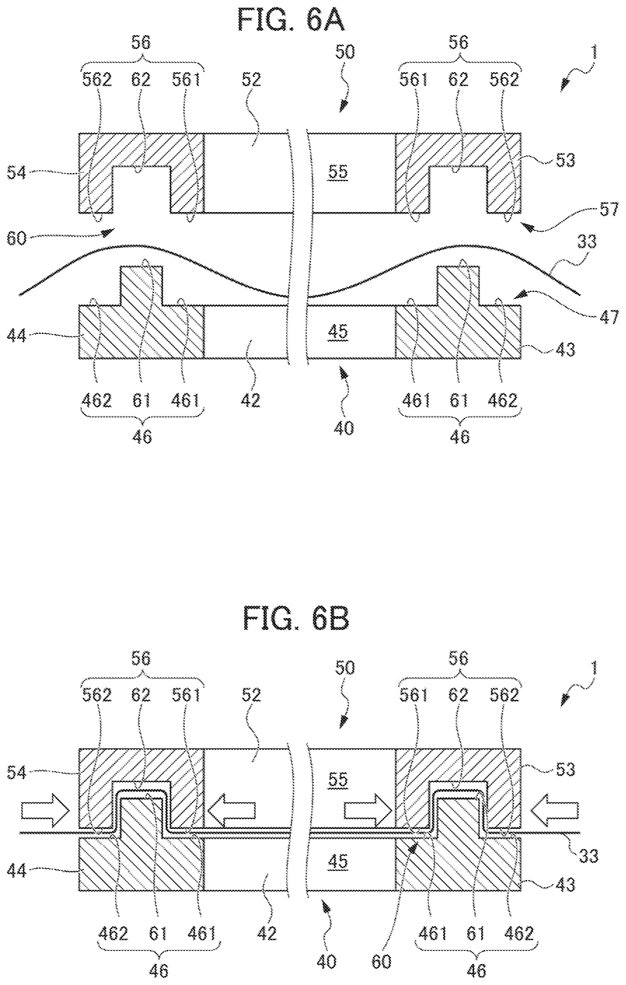

Next, the configurations of the sandwiching portions 46, 56 will be described with reference to FIGS. 4 to 7. FIG. 5 is a partial sectional view of the manufacturing tool 1 along an A-A line of FIG. 1. FIGS. 6A and 6B are partial sectional views of the manufacturing tool 1 along a B-B line of FIG. 1. FIG. 6A shows a state in which the base 33 is arranged between the first frame member 40 and the second frame member 50 separated from each other. FIG. 6B shows a state in which the base 33 is sandwiched between the first frame member 40 and the second frame member 50.

As shown in FIGS. 5 and 6A, the sandwiching portion 46 has a raised portion 61 protruding from the opposing surface 47 and an inner surface 461 and an outer surface 462 formed on both sides of the raised portion 61 in a width direction of the first frame member 40.

The raised portion 61 is provided so as to continuously extend in the length directions of the upper frame portion 41, the lower frame portion 42, and the vertical frame portions 43, 44 on the surface 47. That is, the raised portion 61 is continuously provided along the shape of the first frame member 40. As shown in FIGS. 5 to 6B, the raised portion 61 is provided on the center side of the first frame member 40 in the width direction thereof.

The inner surface 461 is on an opening 45 side in the width direction of the first frame member 40. The outer surface 462 is on the outside (the side opposite to the opening 45) in the width direction of the first frame member 40. Portions of the first frame member 40 formed with the inner surface 461 and the outer surface 462 have the substantially same thickness, and are formed thinner than the raised portion 61. That is, the raised portion 61 is formed so as to protrude toward the sandwiching portion 56 from the surface including the inner surface 461 and the outer surface 462 with the base 33 sandwiched between the sandwiching portions 46, 56 as shown in FIG. 6B.

As shown in FIG. 6A, the sandwiching portion 56 has a recessed portion 62 formed at the opposing surface 57 and an inner surface 561 and an outer surface 562 formed on both sides of the recessed portion 62 in a width direction of the second frame member 50.

The recessed portion 62 is provided at the sandwiching portion 56 such that the recessed portion 62 can receive the raised portion 61 with the base 33 sandwiched between the recessed portion 62 and the raised portion 61. Specifically, the recessed portion 62 is provided so as to continuously extend in the length directions of the upper frame portion 51, the lower frame portion 52, and the vertical frame portions 53, 54 on the surface 57. That is, the recessed portion 62 is continuously provided along the shape of the second frame member 50. As shown in FIGS. 5 to 6B, the recessed portion 62 is provided on the center side of the second frame member 50 in the width direction thereof.

The inner surface 561 is on an opening 55 side in the width direction of the second frame member 50. The outer surface 562 is on the outside (the side opposite to the opening 55) in the width direction of the second frame member 50. Portions of the second frame member 50 formed with the inner surface 561 and the outer surface 562 have the substantially same thickness, and are formed thicker than the recessed portion 62. That is, the recessed portion 62 is formed so as to be recessed toward the side opposite to the sandwiching portion 46 from the surface including the inner surface 561 and the outer surface 562 with the base 33 sandwiched between the sandwiching portions 46, 56 as shown in FIG. 6B.

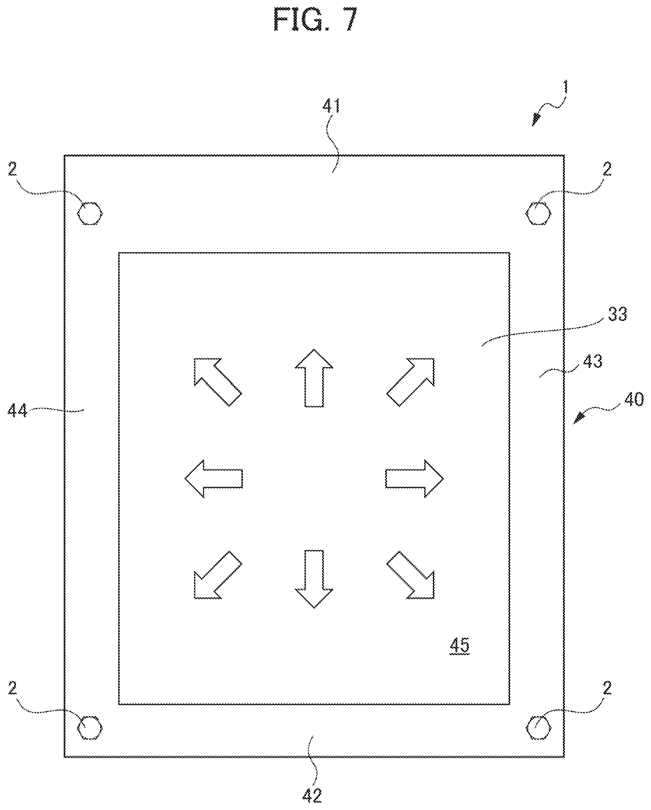

Next, the state of the base 33 sandwiched by the manufacturing tool 1 will be described with reference to FIGS. 6A to 7. FIG. 7 is a front view schematically showing the base 33 sandwiched by the manufacturing tool 1.

Before the base 33 is filled with the solid electrolyte material, the base 33 is, as shown in FIG. 6A, in a state in which the base 33 is not tensioned, but is slightly loosened. The base 33 is sandwiched between the sandwiching portions 46, 56 as shown in FIG. 6B so that the base 33 can be pulled into a portion where the raised portion 61 is received by the recessed portion 62. Accordingly, the base 33 is tensioned in the direction of white arrows. That is, the sandwiching portions 46, 56 each include the raised portion 61 and the recessed portion 62, and form a recessed-raised structure 60 which is a fixing structure for providing tension to the sandwiched base 33. As shown in FIG. 7, a portion, which is exposed through the openings 45, 55, of the base 33 sandwiched by the manufacturing tool 1 is tensioned outward in a planar direction as indicated by white arrows by the recessed-raised structure 60 having the raised portion 61 and the recessed portion 62. With this configuration, wrinkling and loosening of the base 33 can be reduced.

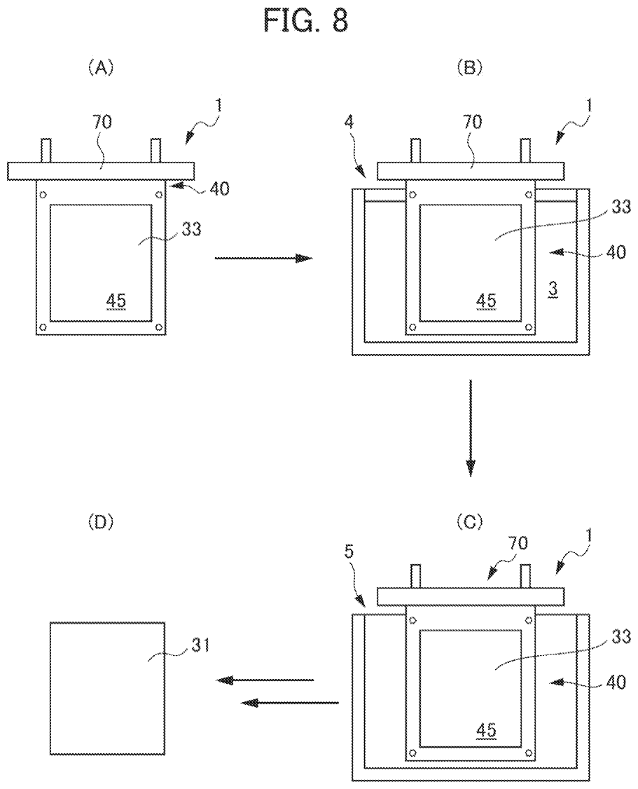

Next, a method for manufacturing the solid electrolyte sheet 31 by the manufacturing tool 1 according to the present embodiment will be described. FIG. 8 is a schematic view for describing steps of manufacturing the solid electrolyte sheet 31 by the manufacturing tool 1.

First, the base 33 is arranged between the first frame member 40 and the second frame member 50, and the bolts 2 are screwed into the through-holes 48, 58 with the first frame member 40 and the second frame member 50 overlapping with each other. Accordingly, the base 33 is attached to the manufacturing tool 1 in a tensioned state as shown in (A) of FIG. 8.

As shown in (B) of FIG. 8, the base 33 attached to the manufacturing tool 1 is dipped in solid electrolyte slurry 3 in a dipping tank 4. At this point, the solid electrolyte slurry 3 adheres to the base 33 through the openings 45, 55. Then, the base 33 is taken out of the dipping tank 4 after lapse of a predetermined time, and then, is dipped again in the dipping tank 4. This process is repeated a predetermined number of times. Note that the solid electrolyte slurry 3 is a mixture of, e.g., liquid butyl acetate slurry, the solid electrolyte material, and the binder.

Subsequently, as shown in (C) of FIG. 8, the base 33 applied with the solid electrolyte slurry 3 is dried with the hanger 70 of the manufacturing tool 1, to which the base 33 is attached, hung on a drying rack 5.

After lapse of a predetermined time, the manufacturing tool 1 is taken out of the drying rack 5, and the base 33 is detached from the manufacturing tool 1. In this manner, the solid electrolyte sheet 31 configured such that the base 33 is filled with the solid electrolyte material is manufactured as shown in (D) of FIG. 8.

### Examples

Next, an example of the present invention will be described, but the present invention is not limited to this example.

In the example, a test was conducted to evaluate variation in the thickness of a solid electrolyte sheet obtained using the manufacturing tool 1 according to the present example.

As the example, three rectangular solid electrolyte sheet samples were produced by the above-described method for manufacturing the solid electrolyte sheet 31 by the manufacturing tool 1 according to the embodiment. As a comparative example, three rectangular solid electrolyte sheet samples were produced by the same method as that of the example, except that a manufacturing tool different from the manufacturing tool 1 used for the example was used. The manufacturing tool used for the comparative example is different from the manufacturing tool 1 in that no recessed-raised structure 60 is formed by sandwiching portions 46, 56. Specifically, the manufacturing tool used for the comparative example has flat opposing surfaces 47, 57 including the sandwiching portions 46, 56. That is, in the comparative example, the manufacturing tool which does not have a function of providing tension to a base is used, unlike the manufacturing tool 1.

In order to obtain the average thickness of the solid electrolyte sheet, film thicknesses at a total of four points in the vicinity of four corners of each sample were measured, and the average thickness (μm) and the standard deviation (o) thereof were calculated for each sample.

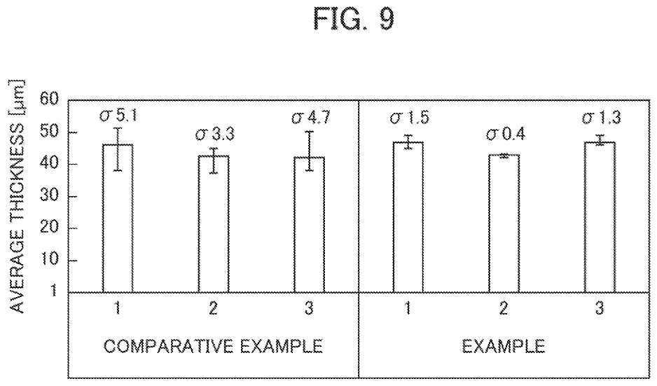

FIG. 9 is a graph showing the average thickness of the solid electrolyte sheet and variation in the thickness in the example and the comparative example. The horizontal axis of FIG. 9 indicates the numbers of the three samples of each of the comparative example and the example, and the vertical axis indicates the average thickness (μm) of the solid electrolyte sheet. The standard deviation (σ) of the thickness is shown above each bar graph for each sample.

As shown in FIG. 9, all the samples of the comparative example showed a standard deviation of 3.0 or more, whereas all the samples of the example showed a standard deviation of 1.5 or less. This result shows that variation in the thickness of the manufactured solid electrolyte sheet can be reduced by use of the manufacturing tool 1 having the recessed-raised structure 60.

The manufacturing tool 1 for the solid electrolyte sheet 31 according to the above-described embodiment produces the following effects.

The manufacturing tool 1 for the solid electrolyte sheet 31 according to the present embodiment is the manufacturing tool 1 for the solid electrolyte sheet 31 configured such that the porous base 33 is filled with the solid electrolyte material. The manufacturing tool 1 includes the first frame member 40 and the second frame member 50 each having the opposing sandwiching portions 46, 56 and sandwiching the base 33 by the sandwiching portions 46, 56. The sandwiching portions 46, 56 provide the fixing structure configured to provide tension to the sandwiched base 33.

With this configuration, tension can be provided to the base 33, and therefore, wrinkling and loosening of the base 33 can be reduced. The solid electrolyte sheet 31 obtained in such a manner that the base 33 in this state is filled with the solid electrolyte material is thin, is less likely to vary in thickness, and is more likely to have a uniform density of the solid electrolyte layer 30. As a result, in a case where the solid electrolyte sheet 31 is stacked to form a cell, uniform thickness distribution can be obtained, and degradation of battery performance can be reduced. Thus, energy efficiency is improved.

In the manufacturing tool 1 for the solid electrolyte sheet 31 according to the present embodiment, the fixing structure is the recessed-raised structure 60.

With this configuration, the fixing structure can be simply formed, and the solid electrolyte sheet 31 can be easily obtained with less thickness variation at low cost.

In the manufacturing tool 1 according to the present embodiment, the recessed-raised structure 60 includes the raised portion 61 continuously provided at the sandwiching portion 46 of the first frame member 40 and the recessed portion 62 provided at the sandwiching portion 56 of the second frame member 50 such that the recessed portion 62 can receive the raised portion 61 with the base 33 sandwiched between the recessed portion 62 and the raised portion 61.

With this configuration, the recessed-raised structure 60 can be simply formed, and the solid electrolyte sheet 31 can be easily obtained with less thickness variation at low cost.

The specific embodiment of the present invention has been described above, but the present invention is not limited to the above-described embodiment and changes, modifications, etc. made within a scope in which the object of the present invention can be achieved are also included in the scope of the present invention.

### EXPLANATION OF REFERENCE NUMERALS

1 Manufacturing Tool
31 Solid Electrolyte Sheet
33 Base
40 First Frame Member
46, 56 Sandwiching Portion
50 Second Frame Member
60 Recessed-Raised Structure (Fixing Structure)

What is claimed is:

1. A manufacturing tool for a solid electrolyte sheet configured such that a porous base is filled with a solid electrolyte material, comprising:
a first frame member and a second frame member each having opposing sandwiching portions and sandwiching the base by the sandwiching portions,
wherein the sandwiching portions provide a fixing structure configured to provide tension to the sandwiched base.

2. The manufacturing tool for the solid electrolyte sheet according to claim 1, wherein the fixing structure is a recessed-raised structure.

3. The manufacturing tool for the solid electrolyte sheet according to claim 2, wherein
the recessed-raised structure includes
a raised portion continuously provided at the sandwiching portion of the first frame member and
a recessed portion provided at the sandwiching portion of the second frame member such that the recessed portion can receive the raised portion with the base sandwiched between the recessed portion and the raised portion.
